(19) United States
(12) Patent Application Publication
(10) Pub. No.: US 2006/0187887 A1
(43) Pub. Date: Aug. 24, 2006

(54) Wireless multiple access system for suppressing inter-cell interference

(75) Inventors: Bong Hoe Kim, Ansan-si (KR); Joon Kui Ahn, Seoul (KR); Hak Seong Kim, Seoul (KR); Dong Youn Seo, Seoul (KR); Dong Wook Roh, Seoul (KR)

Correspondence Address: JONATHAN Y. KANG, ESQ.;LEE, HONG, DEGERMAN, KANG & SCHMADEKA, P.C., 14th Floor, 801 S. Figueroa Street, Los Angeles, CA, 90017-5554, US

(73) Assignee: LG Electronics Inc.

(21) Appl. No.: 11/349,648

(22) Filed: Feb. 7, 2006

(30) Foreign Application Priority Data
Feb. 18, 2005 (KR) 10-2005-000137
May 2, 2005 (KR) 10-2005-036813

(51) Int. Cl. H04B 7/216

(52) U.S. Cl. 370/335; 370/208

(57) ABSTRACT

An OFDM based multiple access system provides strong persistence against selective frequency fading and further provides suppression of inter-cell interference by using cell differentiating scrambling codes. Thus, the OFDM system maximizes frequency reuse rate. The present invention includes an OFDM modulator frequency-division-multiplexing data to be transmitted, a code division unit multiplexing the frequency-division-multiplexed data with a prescribed code, and an RF end converting the data multiplexed by the code division unit to a radio frequency signal to transmit. Accordingly, the present invention raises the degree of freedom (frequency division, time division, code division) of system implementation in the multiple access system. The OFDM system includes the scrambling of the downlink data by different scrambling codes by a cell unit for base stations within at least two neighboring cells to identify the respective cells and transmitting the spread downlink data.

### CROSS-REFERENCE TO RELATED APPLICATIONS

Pursuant to 35 U.S.C. § 119(a), this application claims the benefit of earlier filing date and right of priority to Korean Application No. 2005-000137, filed Feb. 18, 2005, and Korean Application No. 2005-036813, filed May 2, 2005, the contents of which are hereby incorporated by reference herein in their entirety.

### FIELD OF THE INVENTION

The present invention relates to a wireless mobile communication system, and more particularly, to an orthogonal frequency division multiplexing (OFDM) and code division multiple access (CDMA) system to resolve an inter-cell interference problem.

### BACKGROUND OF THE INVENTION

In the OFDM system which uses a plurality of carriers having mutual orthogonality, a frequency use efficiency is raised. A process of modulating/demodulating a plurality of the carriers in a transmitting/receiving end brings the same result of performing IDFT (Inverse Discrete Fourier Transform)/DFT (Discrete Fourier Transform). The process can be implemented by using IFFT (Inverse Fast Fourier Transform)/FFT (Fast Fourier Transform).

In the OFDM system, a high speed data stream is divided into a plurality of low speed data streams, and the low speed data streams are transmitted simultaneously using a plurality of sub-carriers. Therefore, the OFDM system may increase symbol duration and reduce relative dispersion in time domain caused by multi-path delay spread. And, the data transmission adopting the OFDM is performed by the unit of symbol.

In an OFDMA (OFDM Acess) physical layer, active carriers are separated into groups and each of the groups is transmitted to a corresponding receiving end. Thus, a group of carriers transmitted to one receiving end is called a sub-channel. The carriers configuring each of the sub-channels are adjacent to each other or can be uniformly spaced apart from each other in a frequency domain. The multiple access using a plurality of sub-channels may cause complexity in implementation, but it may bring advantage such as frequency diversity gain, power concentration, and efficient forward link power control.

A slot allocated to each user is defined by a 2-dimensional data region, and it is a set of continuous sub-channels allocated by a burst. A data region in OFDMA is represented as a rectangular figure in a two dimensional time-frequency coordinates, herein the frequency axis is defined as each sub-channel.

In an uplink transmission, a data region is allocated to a specific user. But, in a downlink transmission, a base station transmits data through another data region.

In order to define such a data region in a 2-dimensional coordinates, the number of OFDM symbols in a time axis and the number of continuous sub-channels starting from a position apart from a reference point with an offset in a frequency axis should be given.

In the downlink multiple access method using multiple carriers, such as the conventional OFDMA, a frequency scheduling scheme is mainly used between neighbor cells to suppress inter-cell interference. Namely, the inter-cell interference is suppressed in a manner of performing scheduling on frequencies not to use different carriers between the neighbor cells. However, if a cell load is heavy, it is difficult to maintain a high frequency reuse rate (˜1) or to avoid the increasing inter-cell interference.

Lately, high speed data rate and high frequency use efficiency are tended to be accepted as basic requirements, whereby the frequency reuse rate close to ‘1’ is demanded. In this case, if the number of users is raised to increase user traffics, it is difficult to efficiently allocate inter-cell frequency resources. So, it is highly probable that a user using the same frequency may exist in a neighbor cell, whereby the inter-user interference problem becomes more serious.

Considering the tendency of a traffic increase in a current mobile communication system, it is expected that a future mobile communication system to be used in few years later will need a bandwidth 1˜100 times wider than that of the current mobile communication system. In case of applying a single frequency system to such a broadband system, various problems may occur. The most significant problems are selective frequency fading that occurs across a broadband and Doppler effect due to a motion of terminal and the like.

To reduce such a fading, a very complicated equalizer is needed. Hence, a transmitting method, in which a broadband is divided into several sub-carriers is favorable. And, a receiver equalization process becomes very simplified if the transmission is performed using the sub-carriers with bandwidth unit, which can ignore the selective frequency fading, i.e., which can be regarded as a flat fading channel.

As shown in FIG. 1, in a wireless mobile communication system, to use sub-carriers, which are orthogonal to each other improves frequency efficiency. This is called orthogonal frequency division multiplexing (hereinafter abbreviated OFDM).

FIG. 1 shows an arranged form of OFDM sub-carriers that are widely used. In this case, fᵢ (i=0, 1, 2, . . . , N−1) indicates N sub-carriers and Δf indicates a sub-carrier interval.

OFDMA is a technique of applying frequency division based on the OFDM modulation to identify a multiplexed user. The OFDMA is a system enabling several users to perform transmissions with different frequencies in a manner of allocating frequency (sub-carrier) bands to the users by a proper scheduling scheme.

FIG. 2 is a block diagram of a transmitting end of an OFDM system according to a related art. Referring to FIG. 2, a transmitting end of an OFDM system according to a related art comprises an OFDM modulator 10 modulating and multiplexing data with sub-carriers, and an RF end 11 converting the data to RF signal.

The OFDM modulator 10 comprises a serial/parallel (S/P) converter 10-1 converting serial data (symbols) of baseband to a plurality of parallel data (sub-channels) and an IFFT (inverse fast Fourier transform) unit 10-2 multiplexing the parallel data into sub-carriers. To simplify the drawing, it is assumed that a CP (cyclic prefix) for minimizing an ISI influence caused by a timing error of a transmission OFDM symbol and other supplementary functions are carried out by the IFFT unit 10-2. A receiving end of the OFDM system has a configuration reverse to that of the transmitting end of the OFDM system.

Referring to FIG. 2, the serial data converted to the baseband is converted to a plurality of the parallel data (sub-channels) by the serial/parallel (S/P) converter 10-1. And, each of the parallel-converted data is multiplexed into the sub-carrier by the IFFT unit 10-2. The RF end 11 converts the data multiplexed by the IFFT unit 10-2 to the RF signal and then transmits the RF signal to the receiving end via an antenna.

In a wireless mobile communication system, OFCDM (orthogonal frequency code division multiplexing), which caries out multiplexing using codes, is used for user and channel identifications.

FIG. 3 is a block diagram of a transmitting end of an OFCDM system 25. Referring to FIG. 3, a transmitting end of an OFCDM system comprises an OFCDM modulator 20 multiplying data by an orthogonal code and multiplexing the multiplied data into a sub-carrier and an RF unit 21 converting the data multiplexed by the OFCDM modulator 20 to an RF signal.

The OFCDM modulator 20 comprises a serial/parallel (S/P) converter 20-1 converting serial data of baseband to a plurality of parallel data (sub-channels), a CDM (code division multiplexing) processing unit 20-2 multiplies each of the parallel data by a (pseudo) orthogonal code, and an IFFT (inverse fast Fourier transform) unit 20-3 converts the parallel data into sub-carriers, and having such a supplementary function as a CP (cyclic prefix). A receiving end of the OFCDM system has a configuration reverse to that of the transmitting end of the OFCDM system 25.

Referring to FIG. 3, data modulated into the baseband are separated into sub-data (sub-channel) by the serial/parallel (S/P) converter 20-1. Each of the separated sub-channels is multiplexed with the orthogonal code by the CDM processing unit 20-2. The data multiplexed by the CDM processing unit 20-2 is multiplexed into the sub-carrier by the IFFT unit 20-3. The RF unit 21 converts the data multiplexed by the IFFT unit 20-2 of the OFCDM modulator 20 to the RF signal and then transmits the RF signal via at lease one antenna.

As mentioned in the foregoing description, the orthogonal frequency division multiplexing access (OFDMA) system is used in preventing signal distortion caused by the selective frequency fading across a wide frequency band in case of introducing the single frequency system to the broadband system. Specifically, in the OFDMA system, to maintain a high frequency reuse rate and to minimize reduction of a cell throughput due to the interference from load increment, a cell interference averaging scheme, a cell interference evading scheme and the like are used. However, in the cellular mobile communication system, the frequency reuse rate of the OFDMA system is basically smaller than that of the CDMA system and user and channel identifications depend on the frequency and time divisions only.

The OFDM or OFCDM technique is superior to the single frequency system or the conventional CDMA system in an isolated single cell environment. However, when using the OFDMA or OFCDM technique for the cellular mobile communication system having several cells neighboring to each other, there are several problems to be solved. One of the problems is inter-cell interference caused by neighboring cells. In the conventional CDMA based cellular mobile communication system, which identifies cells from each other with different pseudo-orthogonal codes, it is possible to suppress the interference to some extent or eliminating the interference.

However, in the OFDMA or OFCDM system having the frequency reuse rate set to 1, since the same frequency band (frequency reuse rate=1) is allocated to all cells, the inter-cell interference significantly occurs in a cell boundary in case of overload even if an inter-cell power control is carried out. Although many efforts have been made to solve the problem, there still remain many rooms to be improved by considering the high frequency use rate and the inter-cell interference.

Even if so, the reason why the broadband system prefers the OFDM system to the CDMA system is that the problems of the selective frequency fading (in case of single frequency implementation), the frequency use rate reduction (multiple carrier CDMA or N×CDMA) and the like take place in case of introducing the CDMA based cellular mobile communication system into the broadband system (single carrier CDMA or fixed band CDMA including a multitude of carriers).

### SUMMARY OF THE INVENTION

Accordingly, the present invention is directed to an apparatus for multiple access and method thereof that substantially obviates one or more problems due to limitations and disadvantages of the related art.

An object of the present invention is to provide an apparatus for multiple access in a next generation mobile communication system requiring broadband communication and strong persistence against selective frequency fading and suppressing inter-cell interference to maximize the frequency reuse rate.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method of transmitting data using OFDM in a wireless communication system comprises converting an input signal to a plurality of sub-channel signals; multiplying at least one of the plurality of sub-channel signals with an element of a scrambling code to provide substantially orthogonal outputs in at least one of time and frequency domains, wherein the scrambling code is used for differentiating signals transmitted in neighboring cells; and converting the substantially orthogonal outputs to signals by performing inverse fourier transform. Preferably, the scrambling code has either orthogonal or pseudo orthogonal characteristic. Moreover, a length of the scrambling code may be variable.

According to one aspect of the present invention, the scrambling code is applied over at least one of time and frequency domains. The scrambling code comprises one of PN code and orthogonal variable spreading factor (OVSF) code.

According to another aspect of the present invention, the method further comprises multiplying spreading code to each one of the plurality of sub-channel signals to differentiate mobile terminals. Alternatively, the spreading code is multiplied to each one of the plurality of sub-channel signals to differentiate physical channels.

In another embodiment, a method of transmitting data using OFDM in a wireless communication system comprises converting an input signal to a plurality of sub-channel signals; converting the plurality of sub-channel signals to signals by performing inverse fourier transform; and multiplying at least one of the signals with an element of a scrambling code to provide substantially orthogonal outputs in time domain, wherein the scrambling code is used for differentiating signals transmitted in neighboring cells.

According to another embodiment, an apparatus for transmitting data using OFDM in a wireless communication system comprises a serial-to-parallel converter to convert an input signal to a plurality of sub-channel signals; a processing unit operatively connected to the serial-to-parallel converter to multiply at least one of the plurality of sub-channel signals with an element of a scrambling code to provide substantially orthogonal outputs in at least one of time and frequency domains, wherein the scrambling code is used for differentiating signals transmitted in neighboring cells; and a transform unit operatively connected to the processing unit to convert the substantially orthogonal outputs to signals by performing inverse fourier transform.

In another embodiment, an apparatus for transmitting data using OFDM comprises a serial-to-parallel converter to convert an input signal to a plurality of sub-channel signals; a transform unit operatively connected to the serial-to-parallel converter to convert the plurality of sub-channel signals to signals by performing inverse fourier transform; and a processor operatively connected to the transform unit to multiply at least one of the signals with an element of a scrambling code to provide substantially orthogonal outputs in time domain, wherein the scrambling code is used for differentiating signals transmitted in neighboring cells.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention.

FIG. 1 is a diagram of an arranged form of OFDM sub-carriers according to related art.

FIG. 2 is a block diagram of a transmitting end of an OFDM system according to related art.

FIG. 3 is a block diagram of a related art OFCDM system.

FIG. 4 is a graph for explaining an exemplary allocation of a spreading code according to one preferred embodiment of the present invention.

FIG. 5 is a diagram of distribution of users using a cell identification spreading code and other users not using the spreading code to cope with interference in a cellular mobile communication system according to one preferred embodiment of the present invention.

FIG. 6 and FIG. 7 are diagrams for explaining how a CDM system is applicable to the present invention by taking time, frequency and code domains as references.

FIG. 8 is a block diagram of a transmitting end of an OFDM system according to the present invention.

FIG. 9 is a block diagram of an OFDM system according to an embodiment of the present invention.

### DETAILED DESCRIPTION OF PREFERRED EMBODIMENTS

Reference will now be made in detail to the preferred embodiments of the present invention, examples of which are illustrated in the accompanying drawings. Wherever possible, the same reference numbers will be used throughout the drawings to refer to the same or like parts.

The present invention solves an interference problem between downlink cells using a scrambling code of time-frequency domains in a multiple access system using multi-carriers such as OFDMA and the like. For example, each symbol to be transmitted is repeated as many as a specific spreading factor (SF) and is then multiplied by a scrambling code of which length is the specific spreading factor. And, symbols which are multiplied by the scrambling code are transmitted using frequency-time bin amounting to the number of SF.

According to preferred embodiments of the present invention, different scrambling codes, particularly orthogonal codes are allocated to cells respectively. Therefore, other-cell interference may be suppressed or removed.

Preferably, the scrambling codes are applicable to time or frequency domain, and the SF is variable according to cell configuration and air channel condition.

FIG. 4 is a graph for explaining an exemplary allocation of a scrambling code according to one embodiment of the present invention. Referring to FIG. 4, a unit of a frequency domain is a sub-carrier and a unit of a time domain means a symbol time.

For example, if SF=8 as FIG. 4, a symbol is repeated four times in the time domain and is repeated twice in the frequency domain, eight codes C={C₁, C₂, . . . , C₈} are multiplied one-to-one by a frequency-time bin. By mapping different scrambling codes per the frequency-time bin between neighboring cells, downlink data can be transmitted using a same sub-carrier without interference between the neighboring cells. Hence, a frequency use rate can be raised. For instance, in case of ‘SF=8’, it is able to identify eight neighboring cells.

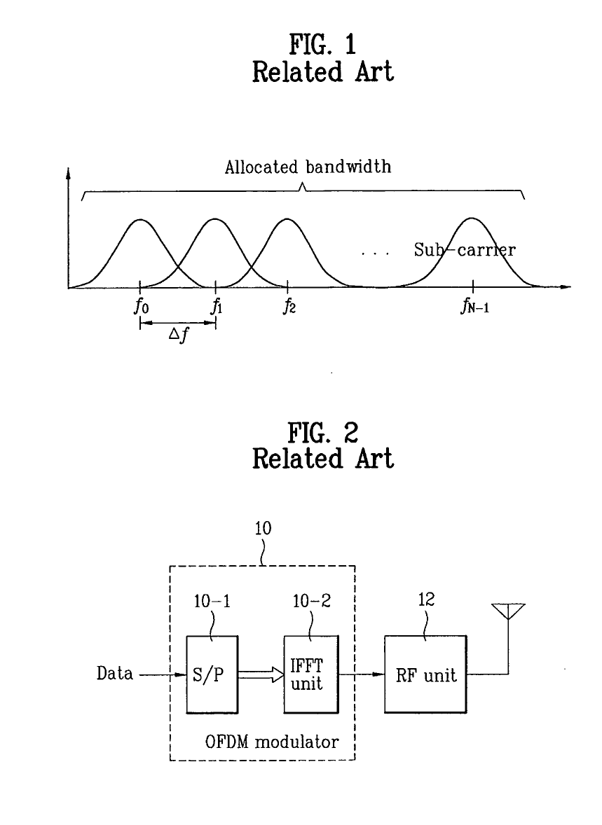

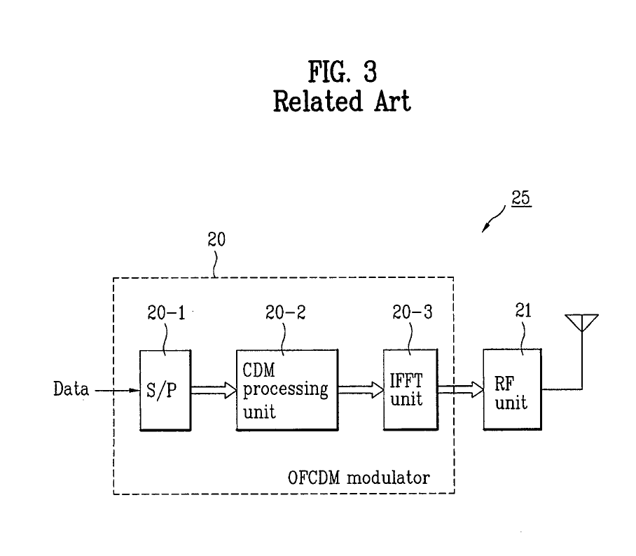

A SF value may be variously applied according to a combination of a time domain spreading factor (SF_{—time}) and a frequency domain spreading factor (SF_{—freq}). For instance, if SF=8, a combination of ‘SF_{—time}=4’ and ‘SF_{—freq}=2’ and a combination of ‘SF_{—time}=4’ and ‘SF_{—freq}=2’ can be applicable. FIG. 1 shows an example of ‘SF=8’, ‘SF_{—time}=4’ and ‘SF_{—freq}=2’. In this case, ‘SF’ is defined by ‘SF_{—time}·SF_{—freq}’.

The SF itself, and the ratio of frequency domain spreading factor or the time domain spreading factor to the SF may be determined based on cell configuration and channel condition. For instance, if the number of cells neighboring to one cell is equal to or smaller than 3, it is able to identify each of the cells just using a spreading factor of ‘SF=4’. Preferably, PN codes, an OVSF (orthogonal variable spreading factor) codes are used as the orthogonal codes. Moreover, a pseudo-orthogonal code can be used as the scrambling code.

It is able to suppress or remove interference between transmission signals of neighbor cells by using inter-code orthogonality or pseudo-orthogonality in a manner of allocating a different code to each base station (cell) which transmits downlink data to each user. In particular, if signal timing synchronization between neighbor cells is maintained, the use of the orthogonal code such as OVSF provides more excellent interference removing capability. Hence, the orthogonal code such as OVSF is preferably used.

The SF of the above-mentioned codes is variable based on cell configuration and channel condition. Hence, under specific condition, for example, if SF=1, the scrambling code may not be applied.

It is not necessary for the entire users within a cell to use a cell identification scrambling code. For example, a terminal to adopt the cell identification scrambling code and a terminal not to adopt the cell identification scrambling code may be classified according to various conditions. And, there are various methods of applying the cell identification scrambling code to a terminal. For instance, there is a method of applying the cell identification scrambling code to a terminal having a required transmission power exceeding a specific critical value, a method of applying the cell identification scrambling code to a terminal by measuring a quantity of downlink interference, a method of applying the cell identification scrambling code to a terminal by estimating a quantity of interference or a signal to interference noise ratio (SINR) according to interference based on a user's location, or the like. Further, it is able to determine to which terminal the cell identification scrambling code is adopted, by combining at lease two above-mentioned methods.

Whether to use the cell identification scrambling code for a specific terminal can be decided in a signaling process between a base station and the specific terminal. Yet, whether to use the cell identification scrambling code can be changed according to a situation after call setup.

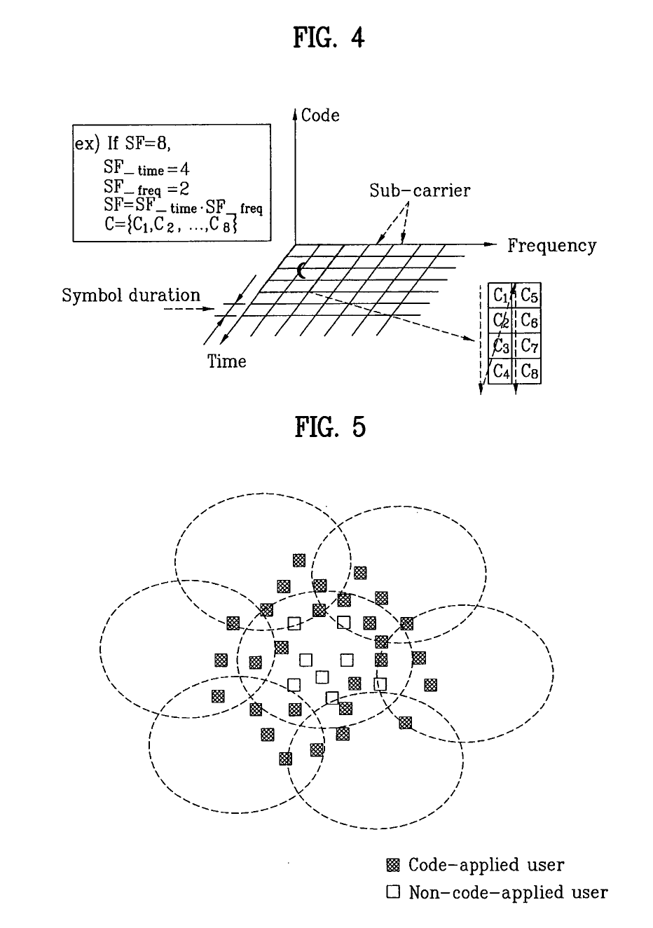

FIG. 5 is a diagram of distribution of users using a cell identification scrambling code and other users not using the scrambling code to cope with interference in a cellular mobile communication system according to one embodiment of the present invention.

Referring to FIG. 5, since interference has mainly influence on users located near a cell edge, it is able to remove inter-cell interference by applying a scrambling code. Yet, since a user's location within a cell does not precisely coincide with a quantity of cell interference, the scrambling can be applied to a user in the vicinity of a base station. This means that a range of applying the scrambling can vary according to the references such as a transmission power, a quantity of interference, a user's location.

The system proposed by the present invention employs the technique of combining OFDM or OFCDM with CDMA. According to one embodiment, data modulation is basically carried out by OFDM or OFCDM. In case of the OFCDM, a user and channel identifying function is carried out by a CDM unit prior to IFFT. In case of the OFDM, a user or channel identification is carried out by FDM with the OFDM modulation. Finally, cell identification (including user and channel) for inter-cell interference suppression/removal is carried out by CDM.

In particular, the OFCDM based method proposed by the present invention is characterized in that an additional CDM executing unit (code division unit) performing cell identification has a user and channel identifying function also, which is performed by a CDM unit of an OFCDM modulator ahead of the CDM executing unit. Hence, the present invention can implement a system suitable for various radio channel environments by parameter re-establishment.

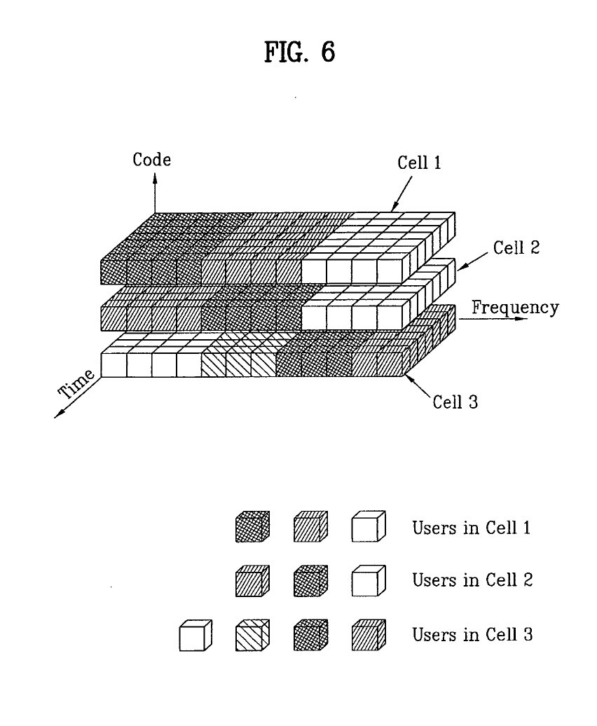

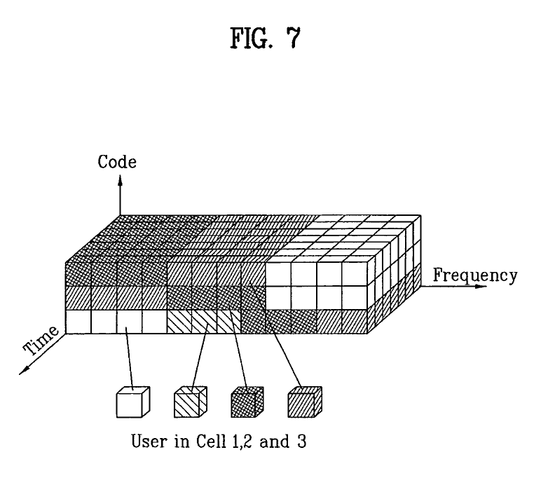

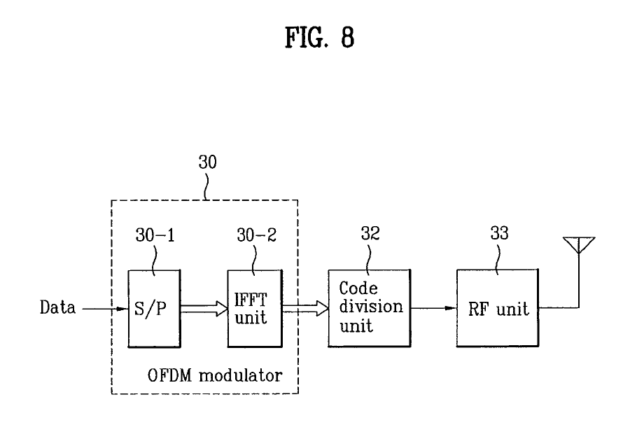

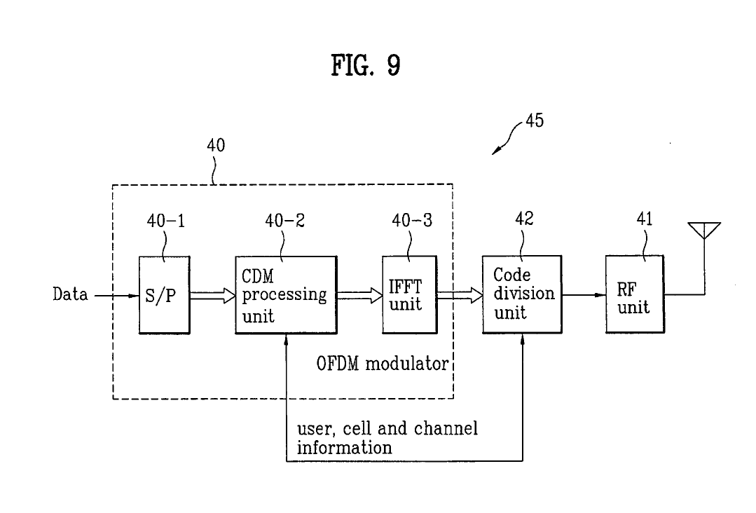

FIGS. 6 and 7 are diagrams for explaining how a CDM system is applicable to the present invention by taking time, frequency and code domains as references. FIGS. 8 and 9 are block diagrams that embody the concept in FIG. 6 and FIG. 7.

FIG. 6 and FIG. 8 show that the code division multiplexing (CDM) scheme is used in identifying cells. The OFDMA scheme (FDM) is applied for user or channel identification, and the CDM scheme is applied for cell identification or differentiation. Where, ‘Cell 1’, ‘Cell 2’ and ‘Cell 3’ in FIG. 6 indicate cells that can be identified with codes, respectively. Even if the cells adjacent to each other use the same frequency band, the cells are able to use the different codes, respectively. Hence, it is able to suppress/remove inter-cell interferences.

FIG. 8 is a block diagram of a transmitting end of an OFDM system according to one embodiment of the present invention. Referring to FIG. 8, a transmitting end of an OFDM system includes the related art OFDM modulator shown in FIG. 2 and further includes a code division unit 32 performing a spreading and/or scrambling function for cell identification.

The code division unit 32 identifies cells using spreading and scrambling scheme with orthogonal codes (pseudo codes) for data multiplexed by the OFDM modulator 30. Preferably, the (pseudo) orthogonal codes can be used by spreading and scrambling (non-spreading) separately or simultaneously. The orthogonal codes, which include codes currently applied to the 3GPP and the 3GPP2 and all kinds of orthogonal or pseudo codes that currently exist, designate all kinds of codes having characteristics in identifying cells, users, user groups and channel groups.

In the transmitting end shown in FIG. 8, the code multiplexing using the orthogonal code is carried out after OFDM modulation in the OFDM modulator (S/P. IFFT, CP: cyclic prefix) 30. The receiving end demultiplexes an RF signal and demodulates the demultiplexed signal in the OFDM demodulator.

The OFDM and CDM combined system illustrated in FIG. 8 performs additional code differentiation to cells from one another. The related art OFDM system is focused not on the cell interference removal but on the user and channel multiplexing. Yet, the proposed OFDM and CDM combined system is focused on solving the cell interference problem by identifying and differentiating cells by performing code multiplexing after the OFDM demodulation. In particular, such a method is applicable to both uplink and downlink. The code used for such process is preferably scrambling code described above with respect to FIGS. 4 and 5.

FIG. 7 and FIG. 9 show that a code division scheme is applicable not only to cell identification but also to user and channel identification.

FIG. 9 is a block diagram of a transmitting end of an OFDM system 45 according to another embodiment of the present invention. Referring to FIG. 9, a transmitting end of an OFDM system includes a code division unit 42 added to the OFDM system. The code division unit 42 identifies cells, users and channels in a manner of spreading and scrambling orthogonal codes (pseudo codes) to data multiplexed by an OFDM modulator 40. Preferably, the (pseudo) orthogonal codes can be used for spreading and scrambling (non-spreading) separately or simultaneously both. The orthogonal codes include codes orthogonal or pseudo orthogonal codes (e.g., scrambling codes) for identifying cells, users, user groups and channel groups.

In particular, the code division unit 42 shown in FIG. 9 mutually exchanges information (user, cell and channel information) with a CDM processing unit 40-2 of the OFDM modulator 40 as well as identifies cells. Hence, the code division unit 42 can raise a degree of freedom in code operations of the users, channels and cells. Moreover, the code division unit 42 can identify one of cell, user channel, user group and channel group. Alternatively, the function of differentiating cells by using different scrambling codes may be implemented in the CDM processing unit 40-2. In other words, the CDM processing unit 40-2 may incorporate the function of the code division unit 42 so that neighboring cells are distinguished by using different scrambling codes, such as orthogonal or pseudo orthogonal codes.

Therefore, the above-explained method raises the degree of freedom (frequency division, time division, code division) of system implementation in the multiple access system (i.e., system design flexibility), thereby facilitating the implementation of the system suitable for various radio channel environments.

Accordingly, the present invention efficiently solves the cell interference problem occurring in the OFDMA or OFCDM system and the selective broadband frequency fading problem, thereby solving the inter-cell interference problem and the fading influence efficiently in various OFDM based broadband systems and thereby raising the frequency reuse rate.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method of transmitting data using orthogonal frequency division multiplexing (OFDM) in a wireless communication system, the method comprising:
converting an input signal to a plurality of sub-channel signals;
multiplying at least one of the plurality of sub-channel signals with an element of a scrambling code to provide substantially orthogonal outputs in at least one of time and frequency domains, wherein the scrambling code is used for differentiating signals transmitted in neighboring cells; and
converting the substantially orthogonal outputs to signals by performing inverse fourier transform.

2. The method of claim 1, wherein the scrambling code comprises orthogonal characteristic.

3. The method of claim 1, wherein the scrambling code comprises pseudo orthogonal characteristic.

4. The method of claim 2, wherein a length of the scrambling code is variable.

5. The method of claim 4, wherein the scrambling code is applied over at least one of time and frequency domains.

6. The method of claim 1, wherein the scrambling code comprises one of PN code and orthogonal variable spreading factor (OVSF) code.

7. The method of claim 1, further comprising; multiplying spreading code to each one of the plurality of sub-channel signals to differentiate mobile terminals.

8. The method of claim 1, further comprising; multiplying spreading code to each one of the plurality of sub-channel signals to differentiate physical channels.

9. A method of transmitting data using orthogonal frequency division multiplexing (OFDM) in a wireless communication system, the method comprising:
converting an input signal to a plurality of sub-channel signals;
converting the plurality of sub-channel signals to signals by performing inverse fourier transform; and
multiplying at least one of the signals with an element of a scrambling code to provide substantially orthogonal outputs in time domain, wherein the scrambling code is used for differentiating signals transmitted in neighboring cells.

10. The method of claim 9, wherein the scrambling code comprises orthogonal characteristic.

11. The method of claim 9, wherein the scrambling code comprises pseudo orthogonal characteristic.

12. The method of claim 10, wherein a length of the scrambling code is variable.

13. The method of claim 12, wherein the scrambling code is applied over at least one of time and frequency domains.

14. The method of claim 9, wherein the scrambling code comprises one of PN code and orthogonal variable spreading factor (OVSF) code.

15. The method of claim 9, further comprising; multiplying spreading code to each one of the plurality of sub-channel signals to differentiate mobile terminals.

16. The method of claim 9, further comprising; multiplying spreading code to each one of the plurality of sub-channel signals to differentiate physical channels.

17. An apparatus for transmitting data using orthogonal frequency division multiplexing (OFDM) in a wireless communication system, the apparatus comprising:
a serial-to-parallel converter to convert an input signal to a plurality of sub-channel signals;
a processing unit operatively connected to the serial-to-parallel converter to multiply at least one of the plurality of sub-channel signals with an element of a scrambling code to provide substantially orthogonal outputs in at least one of time and frequency domains, wherein the scrambling code is used for differentiating signals transmitted in neighboring cells; and
a transform unit operatively connected to the processing unit to convert the substantially orthogonal outputs to signals by performing inverse fourier transform.

18. The apparatus of claim 17, wherein the scrambling code comprises orthogonal characteristic.

19. The apparatus of claim 17, wherein the scrambling code comprises pseudo orthogonal characteristic.

20. The apparatus of claim 18, wherein a length of the scrambling code is variable.

21. The apparatus of claim 20, wherein the scrambling code is applied over at least one of time and frequency domains.

22. The apparatus of claim 17, wherein the scrambling code comprises one of PN code and orthogonal variable spreading factor (OVSF) code.

23. The apparatus of claim 17, wherein the processing unit multiplies spreading code to each one of the plurality of sub-channel signals to differentiate mobile terminals.

24. The apparatus of claim 17, wherein the processing unit multiplies spreading code to each one of the plurality of sub-channel signals to differentiate physical channels.

25. An apparatus for transmitting data using orthogonal frequency division multiplexing (OFDM) in a wireless communication system, the apparatus comprising:
a serial-to-parallel converter to convert an input signal to a plurality of sub-channel signals;
a transform unit operatively connected to the serial-to-parallel converter to convert the plurality of sub-channel signals to signals by performing inverse fourier transform; and
a processor operatively connected to the transform unit to multiply at least one of the signals with an element of a scrambling code to provide substantially orthogonal outputs in time domain, wherein the scrambling code is used for differentiating signals transmitted in neighboring cells.

26. The apparatus of claim 25, wherein the scrambling code comprises orthogonal characteristic.

27. The apparatus of claim 26, wherein the scrambling code comprises pseudo orthogonal characteristic.

28. The apparatus of claim 26, wherein a length of the scrambling code is variable.

29. The apparatus of claim 28, wherein the scrambling code is applied over at least one of time and frequency domains.

30. The apparatus of claim 25, wherein the scrambling code comprises one of PN code and orthogonal variable spreading factor (OVSF) code.

31. The apparatus of claim 25, wherein the processor multiplies spreading code to each one of the plurality of sub-channel signals to differentiate mobile terminals.

32. The apparatus of claim 25, wherein the processor multiplies spreading code to each one of the plurality of sub-channel signals to differentiate physical channels.
